(19) United States
(12) Patent Application Publication
(10) Pub. No.: US 2011/0265631 A1
(43) Pub. Date: Nov. 3, 2011

(54) System and Method for Supporting a Guitar in a Playable Position

(76) Inventor: David Sanchez, (US)

(21) Appl. No.: 13/095,856

(22) Filed: Apr. 28, 2011

Related U.S. Application Data
(60) Provisional application No. 61/328,727, filed on Apr. 28, 2010.

(51) Int. Cl. G10G 5/00

(52) U.S. Cl. 84/327

(57) ABSTRACT

A system and method for supporting a guitar in a playable position. Specifically, a shirt is disclosed. Such shirt can comprise a design printed onto said shirt with said design covering at least a portion of a stomach area of said shirt, and a sticky surface covering a portion of said design. The method can comprise wearing a shirt comprising a sticky surface on a front of said shirt, and pressing guitar body against said sticky surface. Lastly, the method can comprise holding a neck of said guitar.

This application claims the benefit of the provisional application 61/328,727 filed on Apr. 28, 2010.

### BACKGROUND

This disclosure relates to clothing that allows a user to play a guitar standing up.

Traditionally, when a person plays a guitar standing up, he places a guitar strap on the guitar and wears the guitar around his neck. However, guitars can be heavy, and the persistent strap usage can cause pain in the person's neck. Additionally, putting the guitar around the neck and taking it off can be cumbersome.

As such it would be useful to have an improved system and method for supporting a guitar while being played by a user.

### SUMMARY

A system for supporting a guitar in a playable position is disclosed herein. Specifically, a shirt is disclosed. Such shirt can comprise a design printed onto said shirt with said design covering at least a portion of a stomach area of said shirt. Additionally, such shirt can comprise a sticky surface printed over at least a portion of said design.

Further, a method for supporting a guitar in a playable position is disclosed. The method can comprise wearing a shirt comprising a sticky surface on a front of said shirt, and pressing guitar body against said sticky surface. Lastly, the method can comprise holding a neck of said guitar.

### BRIEF DESCRIPTION OF THE DRAWINGS

FIG. 1 illustrates a person playing a guitar.

FIG. 2 illustrates a shirt capable of supporting a guitar.

FIG. 3 illustrates a cut-away view of one embodiment of a comprising a sticky surface.

### DETAILED DESCRIPTION

Described herein is a system and method for supporting a guitar while the guitar is being played. The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

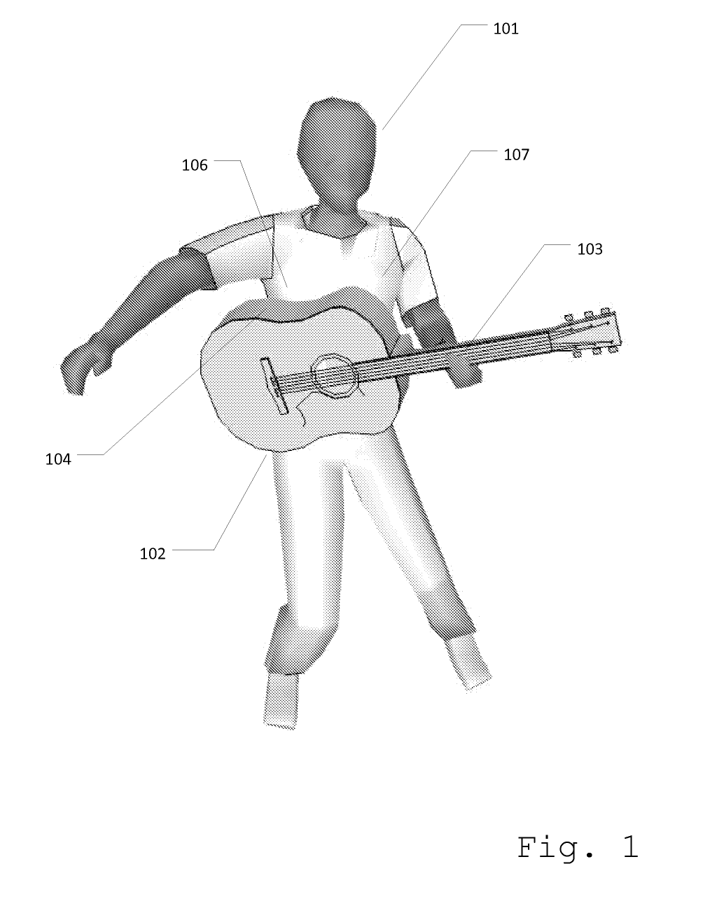

FIG. 1 illustrates a person playing a guitar. When a person 101 plays a guitar 102, person 101 holds a neck 103 of the guitar. A guitar body 104 presses against a shirt 105 worn by person 101. Often when person 101 is right-handed, guitar body 104 presses against a shirt right-side 106, and when person 101 is left-handed, guitar body 104 presses against a shirt left-side 107.

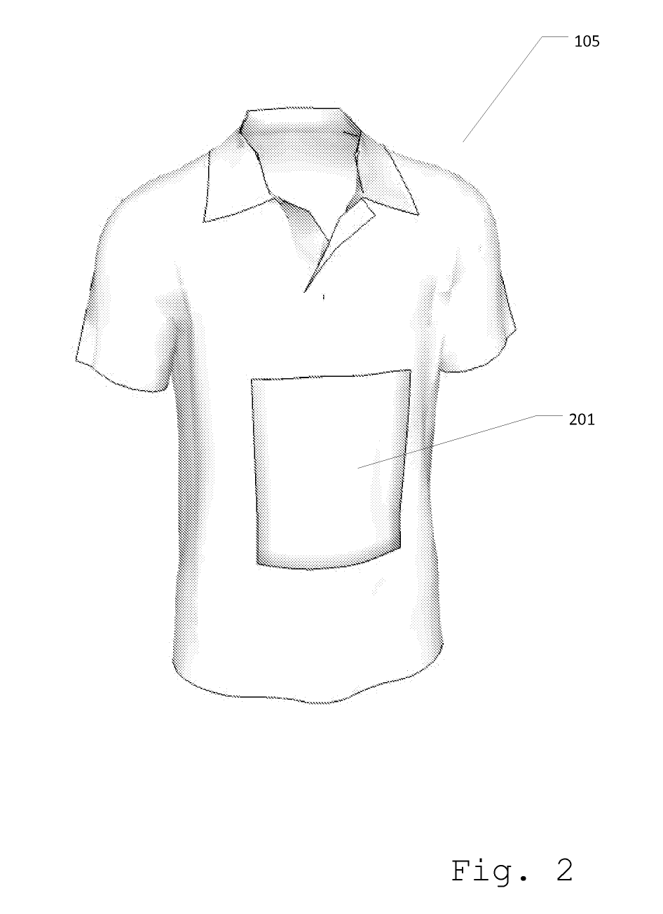

FIG. 2 illustrates shirt 105 capable of supporting guitar 102. In one embodiment, shirt 105 can comprise a sticky surface 201 and a non-sticky surface. As guitar 102 is pressed against the sticky surface, the guitar can resist sliding down the shirt of the user. Sticky surface 201 can be positioned anywhere on the front of shirt 105, however, in a preferred embodiment, sticky surface 201 can be placed on the portion of the surface covering person 101′s stomach, and can be slightly offset to the left or right, depending on whether person 101 is right-handed or left-handed.

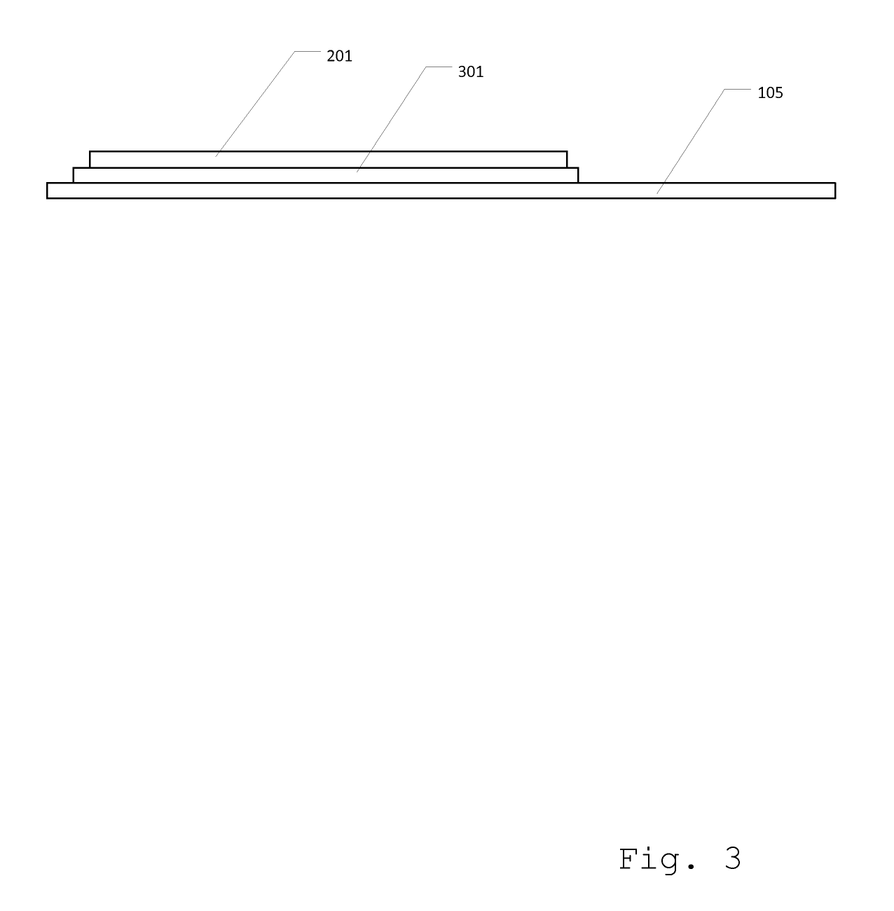

FIG. 3 illustrates a cut-away view of one embodiment of shirt 105 comprising sticky surface 201. In such embodiment sticky surface 201 can attach to a print 301 that is adhered to shirt 105. Print 301 can be an ink design, and can be any image or text affixed to shirt 105. In one embodiment, print 301 can be applied to sticky surface by screen print. Sticky surface 201 can then be applied over print 301. In one embodiment, sticky surface 201 can be applied twice or more times to create more tackiness. In one embodiment, sticky surface 201 can be applied by screen print. In one embodiment, sticky surface 201 can be clear. Further, in one embodiment, sticky surface 201 can be a polymer designed to print onto shirts such as 10009 High Density Clear manufactured by Wilflex®. Both print 301 and sticky surface, 201 can be dried using a high temperature, in one embodiment. Upon placing sticky surface on shirt, person 101 can position guitar 102 in a playable position by pressing the guitar against sticky surface 201. Guitar 102 sticks to sticky surface 201, and hangs off shirt 105. By using shirt 105, person 101 can play guitar 102 with or without a strap.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. A method for supporting a guitar in a playable position comprising
wearing a shirt comprising a sticky surface on a front of said shirt; and
pressing guitar body against said sticky surface; and
holding a neck of said guitar.

2. A system for supporting a guitar in a playable position comprising
a shirt,
a design printed onto said shirt covering at least a portion of a stomach area of said shirt; and
a sticky surface printed over at least a portion of said design.

3. The system of claim 2 wherein said design is printed on a right area of said portion.

4. The system of claim 2 wherein said design is printed on a left area of said portion.

5. The method of claim 2 wherein said sticky surface is a printable polymer.

6. The method of claim 5 wherein said printable polymer is clear.

7. The method of claim 6 wherein said printable polymer is 10009 High Density Clear.
